(19) United States
(12) Patent Application Publication
(10) Pub. No.: US 2007/0211238 A1
(43) Pub. Date: Sep. 13, 2007

(54) Security Element and Methods for the Production Thereof

(75) Inventors: Winfried HOFFMULLER, Bad Tolz (DE); Theodor BURCHARD, Gmund (DE); Thorsten PILLO, Holzkirchen (DE); Manfred HEIM, Munchen (DE)

Correspondence Address: GREENLEE WINNER AND SULLIVAN P C, 4875 PEARL EAST CIRCLE, SUITE 200, BOULDER, CO, 80301, US

(73) Assignee: GIESECKE & DEVRIENT GMBH, Munich (DE)

(21) Appl. No.: 11/568,388

(22) PCT Filed: Apr. 29, 2005
(86) PCT No.: PCT/EP05/04667

§ 371 Date: Oct. 26, 2006

(30) Foreign Application Priority Data
Apr. 30, 2004 (DE) 10 2004 021 246.5
Aug. 12, 2004 (DE) 10 2004 039 355.9
Oct. 29, 2004 (DE) 10 2004 053 007.6

(51) Int. Cl. G06K 9/74

(52) U.S. Cl. 356/71

(57) ABSTRACT

The present invention relates to a transfer material for transfer to a target substrate, and methods for manufacturing such a transfer material. In a method according to the present invention, a plastic substrate foil (32) is provided, an effect layer (34) is applied to the substrate foil (32), a transfer assist layer (36) is applied to the entire surface of the effect layer (34) and the substrate foil (32) is applied, the adhesion of the transfer assist layer (36) to the substrate foil (32) being less than to the effect layer (34). Then an adhesive layer (38) is applied for transferring the formed layered composite to the target substrate (35).

The present invention relates to a method for manufacturing a multilayer security element that exhibits at least one effect layer that requires a special background.

For protection, valuable articles such as branded articles and value documents are often equipped with security elements that permit the authenticity of the valuable articles to be verified, and that simultaneously serve as protection against unauthorized reproduction.

Optically variable elements that, at different viewing angles, give the viewer a different image impression, for example a different color impression, are often used as security elements. Holograms, holographic grid images and other hologram-like diffraction patterns that present the viewer a viewing-angle-dependent diffraction pattern are also often used to safeguard authenticity.

Security elements having hologram-like diffraction patterns are transferred, for instance in the transfer method, to the target substrate, for example a banknote. Here, the detachment of the security element from the substrate foil occurs either through so-called release layers, which for the most part are thermally activatable, or through the low adhesion of the security element to the substrate foil. Furthermore, to facilitate a bond to the paper, the security element is coated with a suitable adhesive system. Other security features, such as glossy pigments or other optically variable effect inks, in contrast, are, for the most part, imprinted directly on a paper substrate. Here, the brilliance and the optical impression of each security element strongly depend on the background.

Based on that, the object of the present invention is to specify a method that avoids the disadvantages of the background art.

This object is solved by the features of the independent claims. Developments of the present invention are the subject of the dependent claims.

In multi-layer security elements, a desired layer sequence is often not possible, since certain security features are preferably manufactured on smooth, non-porous substrates, or in some cases even must be manufactured on such substrates.

Thus, according to the present invention, the special-background-requiring effect layer of a first layered composite is prepared on a separate plastic substrate foil and subsequently transferred to a second layered composite, the second layered composite likewise comprising a plastic substrate foil. Here, the plastic substrate foil of the first layered composite is specially adapted to the requirements of the effect layer.

Thus, for example, certain plastic foils, due to their interior structure, have the property that they align liquid crystal material. In this way, liquid crystal materials can be aligned easily and subsequently transferred to any other layer sequence that, in itself, exhibits no corresponding properties.

But also when the liquid crystal material is aligned by means of alignment layers, the present invention offers the advantage that the alignment layer need not be provided in the layered composite of the security element. This is because the alignment of the liquid crystal material occurs on a separate substrate foil and, subsequently, merely the liquid crystal material is transferred to the layer structure of the security element.

However, there are also other examples of effect layers that require a special background. Vapor deposited, optically variable layers, such as diffraction patterns, interference layer pigments, liquid crystal pigments and metal effect pigments, for example, require a very smooth background to achieve a brilliant color impression or a reflective surface. If the background layer in the desired layer sequence of the security element is not sufficiently smooth, as is the case, for example, with magnetic layers, such layers can be prepared on an optimally prepared background of a plastic substrate foil and subsequently inserted into the layer structure of the security element at the desired location, such as on a rough magnetic layer. For the transfer, preferably an adhesive layer is used that likewise compensates for the rough background.

Of course the security element can be provided with further functional layers, such as electrically conductive, luminescent or magnetic layers, or any imprints. Also further layers manufactured according to the inventive method can be inserted.

The present invention also includes, for manufacturing a first layered composite, especially a transfer material for transfer to a target substrate, a method that comprises the following method steps:
a) providing a plastic substrate foil that exhibits a surface that is adapted to an effect layer to be applied thereto,
b) applying an effect layer to the substrate foil,
c) contiguously applying a transfer assist layer to the effect layer and, if applicable, the substrate foil, the adhesion of the transfer assist layer to the substrate foil being less than to the effect layer, and
d) applying an adhesive layer for transferring the formed layered composite to the target substrate.

Alternatively, the manufacture of a transfer material for transfer to a target substrate can also occur through the following method steps:
a) providing a plastic substrate foil having a release layer,
b) applying an effect layer to the substrate foil,
c) contiguously applying a transfer assist layer to the effect layer and, if applicable, the substrate foil, and
d) applying an adhesive layer for transferring the formed layered composite to the target substrate.

In this alternative, the detachability of the substrate foil is ensured by a release layer that, under the appropriate transfer conditions, aids the separation of the substrate foil from the effect layer and the transfer assist layer. Advantageously, a release layer is used that is thermally activatable under heat sealing conditions.

In both method variations, the effect layer advantageously forms an optically effective effect layer or a reflectively acting effect layer. Here, especially appropriate as an effect layer is a lacquer layer comprising oriented liquid crystal material or a layer having optically variable or metallic pigments that are preferably imprinted.

Furthermore, the effect layer in both method variations is preferably applied discontiguously, especially in the form of patterns, characters or codes.

In the following, the present invention is described in greater detail especially by reference to liquid crystal effect layers to represent any other effect layers. As explained in detail below, such liquid crystal effect layers display certain polarization or color effects.

The liquid crystal material is applied directly to, preferably imprinted on, the plastic substrate foil, preferably without further alignment layers. Preferably, the liquid crystal material is applied discontiguously.

Through the inventive use of a transfer assist layer, also non-contiguously present security elements comprising liquid crystal material, for example printed as a motif, can be transferred to a target substrate. If desired or necessary, the substrate foil for the liquid crystal layer and the transfer assist layer can be removed upon or following the application of the transfer material to the target substrate. The damageless detachability of the substrate foil is ensured by the greater adhesion of the transfer assist layer to the liquid crystal layer.

Furthermore, very complex layer structures can be created through repeated transferring of individual layers or layered composites onto one another, optimal manufacturing conditions being able to be chosen in each case for the individual layers or layered composites through separate manufacture. In this way, according to the present invention, also layered composites that require mutually exclusive manufacturing conditions or mutually interfering substrate foils can be combined, since the substrate foils can be removed upon or following the joining of the sub-layered composites.

In an advantageous development of the present invention, further layers comprising liquid crystal material can be applied discontiguously, especially in the form of patterns, characters or codes, between the liquid crystal layer and the transfer assist layer. Here, these further layers can advantageously overlap at least in part with the first-applied liquid crystal layer.

The liquid crystal layers are advantageously applied, preferably imprinted, as a lacquer layer comprising smectic, nematic or cholesteric liquid crystal material. Here, especially intaglio printing, screen printing, flexo printing or knife or curtain coating are appropriate as printing techniques for the liquid crystal layers and/or the transfer assist layer.

As the transfer assist layer, preferably a UV-curing lacquer layer is applied, especially imprinted. The UV-curing lacquer layer expediently includes photoinitiators. In individual cases, a trade-off must be sought each time between sufficiently high adhesion of the transfer assist layer to the liquid crystal layer to be detached and sufficiently low adhesion to the substrate foil.

In a further preferred embodiment, a layer comprising cholesteric liquid crystal material is applied, especially imprinted, as the transfer assist layer. Also an embossing lacquer layer can advantageously be used as the transfer assist layer. In this case, the embossing lacquer layer is expediently imprinted and thereafter embossed, provided with a reflective layer, especially metallized, and if applicable, demetallized in some areas to introduce, for example, an inverse lettering into the metallized embossing pattern. The embossing pattern advantageously forms an optically effective microstructure, especially a diffraction pattern, a matte pattern, an arrangement comprising microlenses or an arrangement comprising micromirrors.

To achieve better adhesion of subsequently applied layers, for example of a subsequently applied embossing lacquer layer, the transfer assist layer can advantageously be subjected to a corona treatment or furnished with an adhesion promoter.

Prior to the application of the adhesive layer in step d), one or more further layers can be applied to, especially imprinted on, the transfer assist layer to produce more complex layer structures. A further layer can be imprinted on the transfer assist layer, for example with a printing ink, preferably a magnetic ink. Also an embossing lacquer layer can be applied, especially imprinted, as a further layer. Following application, the embossing lacquer layer is advantageously embossed, metallized and, if applicable, demetallized in some areas. A reflective layer can likewise be applied as a further layer.

In all variations having a reflective layer, this layer can also be formed by a reflective thin-film element. Such a thin-film element is preferably formed having a reflection layer, an absorber layer and a dielectric spacing layer disposed between the reflection layer and the absorber layer.

The layered composites already described are joined with one or more further layered composite(s), for example via laminating lacquer layers. In this way it is possible to realize diverse and complex security layer structures. In particular, according to the present invention, a second layered composite that is present on a second substrate foil can be provided that, prior to the application of the adhesive layer in step d), is joined via a second adhesive layer with the layered composite comprising substrate foil, effect layer and transfer assist layer.

In a first variation of the present invention, the second layered composite is manufactured by applying an embossing lacquer layer to the second substrate foil and embossing, metallizing and, if applicable, demetallizing the embossing lacquer layer in some areas.

According to another variation of the present invention, the second layered composite is manufactured in that a screened metal layer having gaps, or a semi-transparent metal layer, is applied on the second substrate foil, and in that a magnetic layer is produced on the metal layer, especially in the form of patterns, characters or codes.

The second layered composite can also comprise a reflective layer. In all variations, the reflective layer can advantageously be formed by a metal layer or, in more complex structures, by a reflective thin-film element having a viewing-angle-dependent color impression. In the latter case, the thin-film element is preferably formed having a reflection layer, an absorber layer and a dielectric spacing layer disposed between the reflection layer and the absorber layer. The reflection layer of the thin-film element is preferably formed from an opaque or semi-transparent metal layer.

The thin-film element can also be formed having at least one absorber layer and at least one dielectric spacing layer, the absorber layers and the dielectric spacing layers being alternatingly stacked. According to a further possible embodiment, the thin-film element is formed having multiple dielectric spacing layers, adjoining layers being formed having strongly different refractive indices.

According to a further variation of the present invention, the second layered composite comprises an optically effective microstructure that is preferably formed as a diffraction pattern, as a matte pattern, as an arrangement of microlenses or as an arrangement of micromirrors.

In the methods according to the present invention, a smooth foil having good surface quality is preferably provided as the substrate foil. In particular, a foil designed especially for the alignment of liquid crystals can be provided. For example, a plastic foil can advantageously be used as the substrate foil. Examples of plastic substrate foils include foils comprising PET, OPP, BOPP, PE and cellulose acetate. The substrate foil can also itself comprise multiple sub-layers, for example the substrate foil can be provided with an alignment layer for aligning liquid crystals. Especially a layer comprising a linear photopolymer, a finely structured layer, i.e. a layer having an alignment-promoting surface topography, or a layer aligned by the application of shear forces may be used as the alignment layer. A suitable finely structured layer can be manufactured, for example, by embossing, etching or scoring.

The present invention also includes a transfer material for transfer to a target substrate that is manufacturable especially according to one of the above-described manufacturing methods and that includes a layer sequence having an effect layer, a contiguously present transfer assist layer that is disposed immediately above the first layer, and an adhesive layer for transferring the layer sequence to the target substrate.

The effect layer is advantageously applied to the substrate foil discontiguously. In an advantageous embodiment, the effect layer is formed by a first layer comprising a liquid crystal, especially comprising a nematic liquid crystal material.

The transfer assist layer preferably comprises a UV-curing lacquer layer, a cholesteric liquid crystal material, or an embossing lacquer layer provided with an embossment.

In an advantageous development of the present invention, at least one further layer comprising liquid crystal material is present between the (discontiguously present) effect layer and the contiguously present transfer assist layer. The at least one further liquid crystal layer is preferably formed from cholesteric liquid crystal material.

In a further advantageous embodiment, the effect layer and the transfer assist layer are present on a plastic substrate foil, the adhesion of the contiguously present transfer assist layer to the substrate foil being less than to the (discontiguously present) effect layer. The effect layer and the transfer assist layer can also be present on a plastic substrate foil that exhibits a release layer, especially a thermally activatable release layer.

Furthermore, the present invention also includes, for securing valuable articles, a security element that is manufacturable especially according to one of the above-described methods, or having a transfer material of the kind described.

In addition, the present invention also comprises a method for transferring a transfer element to a target substrate, in which a transfer material of the kind described is laid with the adhesive layer on the target substrate and joined with the target substrate by heat and/or pressure action. When radiation-curing adhesives are used, the transfer material is expediently joined with the target substrate by pressure and radiation action. Here, the plastic substrate foil of the, if applicable, discontiguously present effect layer is expediently removed upon or shortly after the application to the target substrate.

The method according to the present invention can be used to manufacture any security elements, especially a security thread, a transferable security strip or a patch. The finished security element is, for example, embedded in a security paper or valuable article, especially a value document, or applied to its surface. Here, the security element preferably includes a carrier substrate comprising paper or plastic.

In a method for manufacturing a valuable article, such as a security paper or a value document, a transfer material of the kind described is applied to an article to be secured, especially is affixed by heat and/or pressure action and/or radiation action. Here, the surface of the security paper or valuable article can be specially treated to improve the adhesive action of the security element on the surface, as well as its optical efficiency. For this, especially an adhesion promoter can be used that is applied to the surface of the security paper.

Valuable articles within the meaning of the present invention include especially banknotes, stocks, bonds, certificates, vouchers, checks, valuable admission tickets and other papers that are at risk of counterfeiting, such as passports and other identity documents, as well as product protection elements, such as labels, seals, packaging and the like. In the following, the term “valuable article” encompasses all such articles, documents and product protection means. The term “security paper” is understood to be the not-yet-circulatable precursor to a value document, which precursor can exhibit, in addition to the security element, further authenticating features, such as luminescent substances provided in the volume. Security paper is customarily present in quasi-endless form and is further processed at a later time.

Further exemplary embodiments and advantages of the present invention are explained below by reference to the drawings, in which a depiction to scale and proportion was omitted in order to improve their clarity.

Shown are:

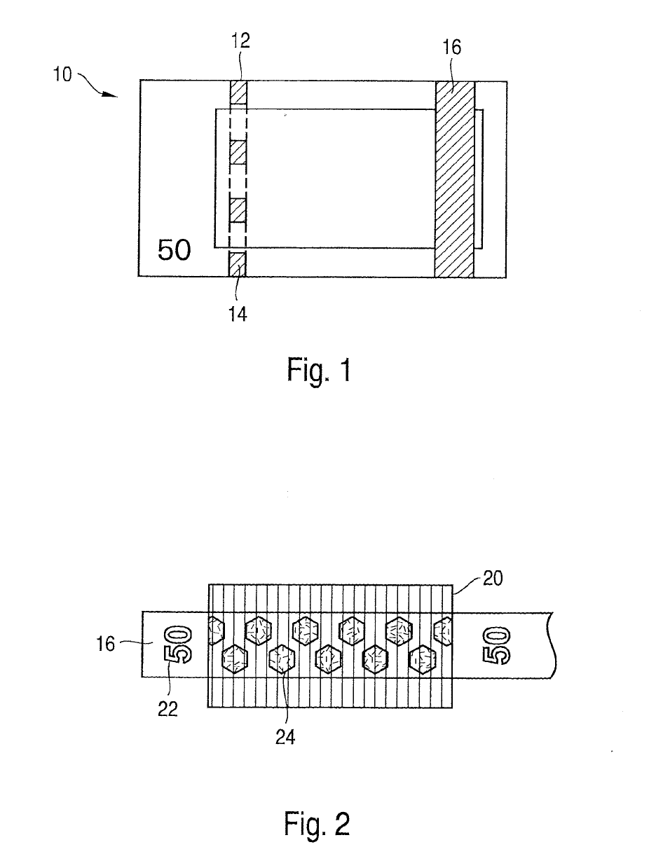

FIG. 1 a schematic diagram of a banknote having an embedded security thread and an affixed security strip, each according to an exemplary embodiment of the present invention,

FIG. 2 a top view of a sub-area of the security strip in FIG. 1 as it appears when viewed without auxiliary means or when viewed through a polarizer,

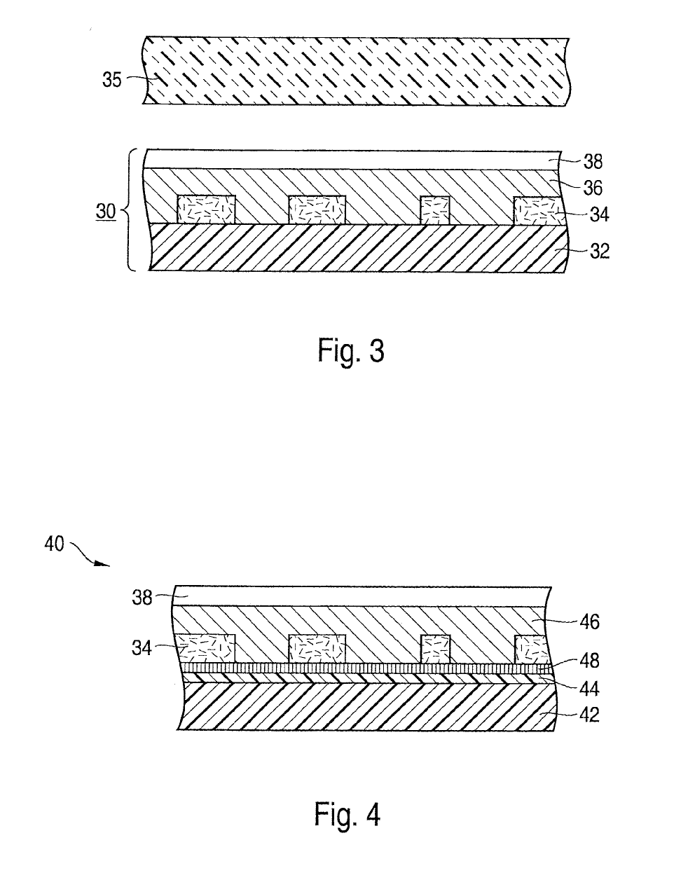

FIG. 3 an intermediate step in the manufacture of a transfer material according to the present invention, in cross-sectional view

FIG. 4 to 6 diagrams as in FIG. 3 of transfer materials according to further exemplary embodiments of the present invention,

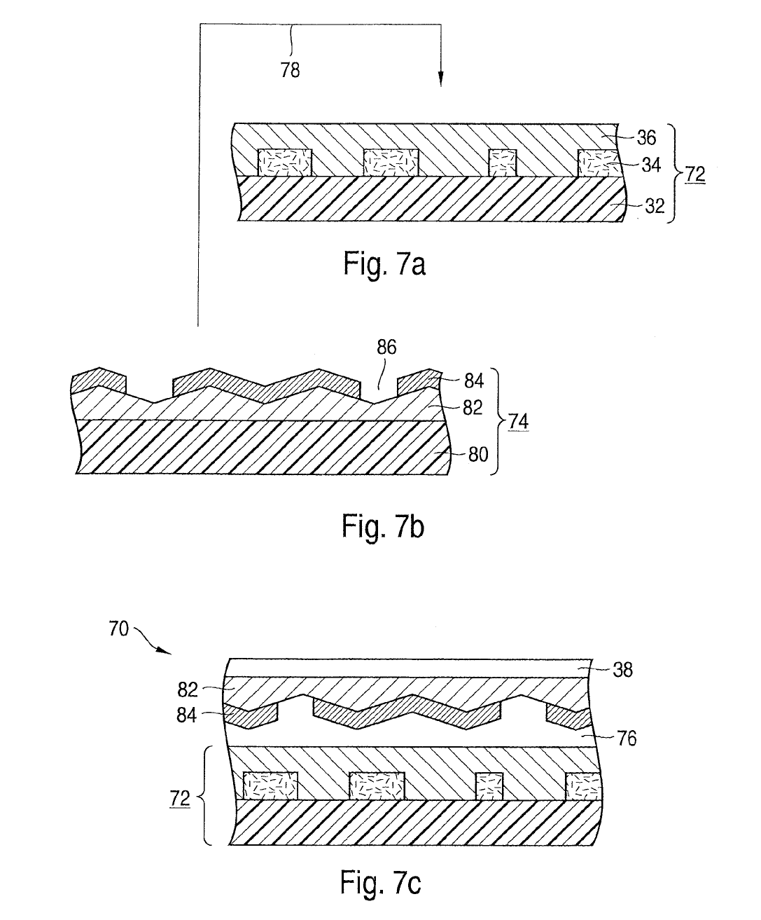

FIG. 7 the manufacture of a multilayer security element according to a further exemplary embodiment of the present invention, wherein (a) and (b) show a first and second layered composite prior to lamination and (c) shows the finished security element,

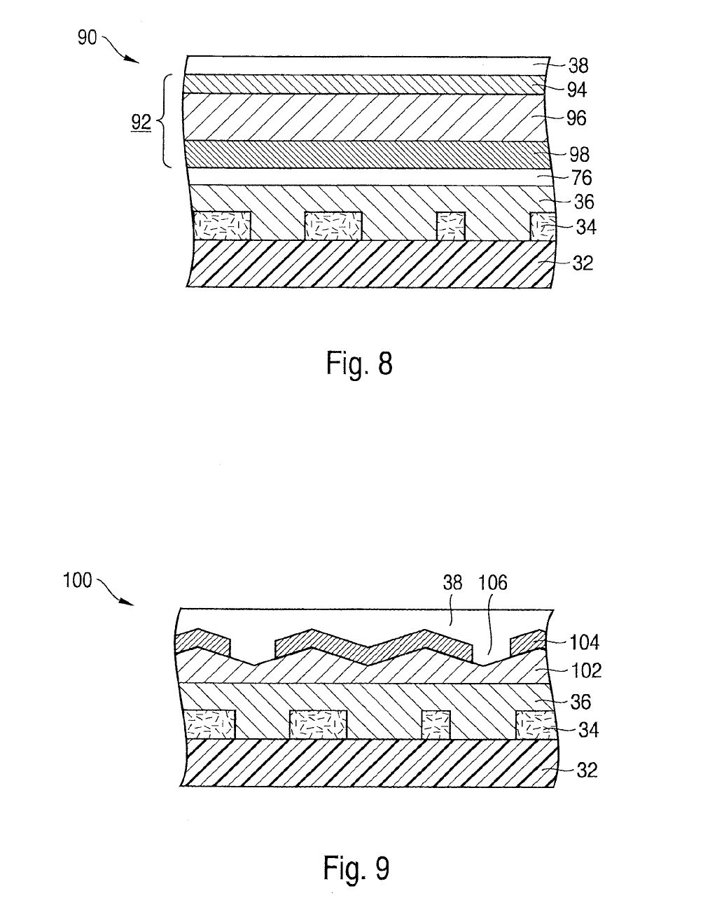

FIG. 8 a diagram of a multilayer security element according to a further exemplary embodiment of the present invention,

FIG. 9 a diagram as in FIG. 3 according to a further exemplary embodiment of the present invention,

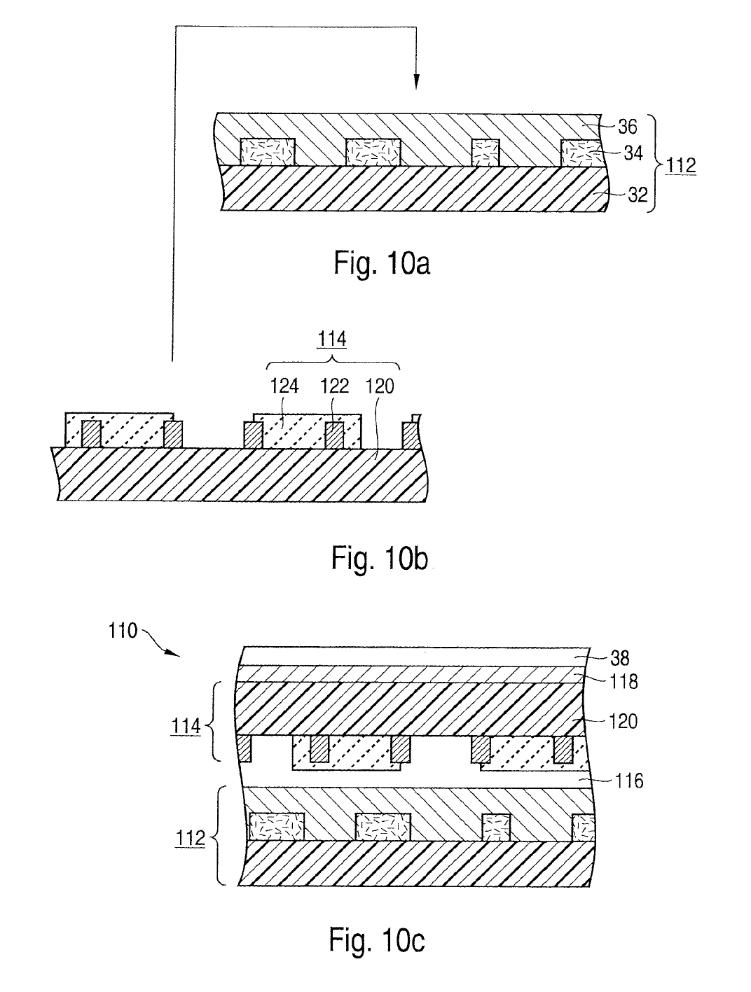

FIG. 10 the manufacture of a multilayer security element according to a further exemplary embodiment of the present invention, wherein (a) and (b) show a first and second layered composite prior to lamination and (c) shows the finished security element,

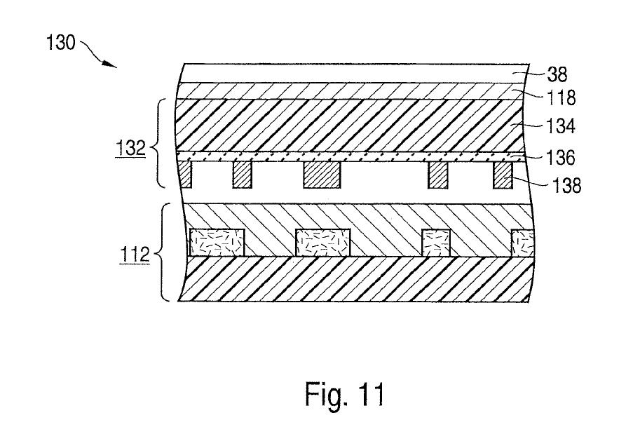

FIG. 11 a variation of the exemplary embodiment in FIG. 1 0(c) that differs therefrom only in the formation of the second layered composite,

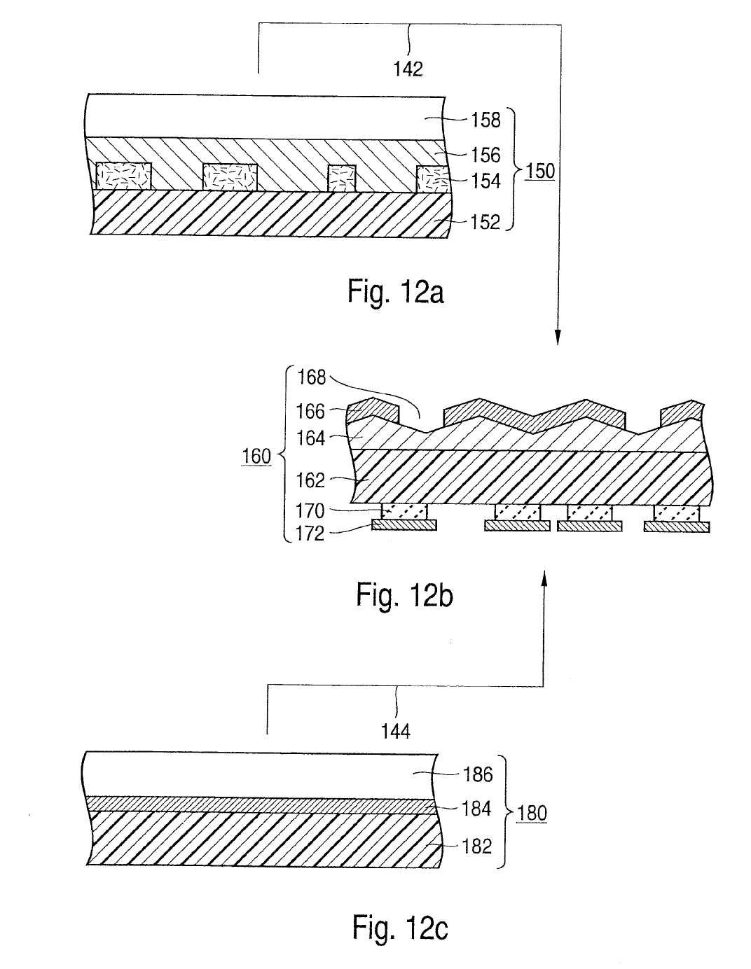

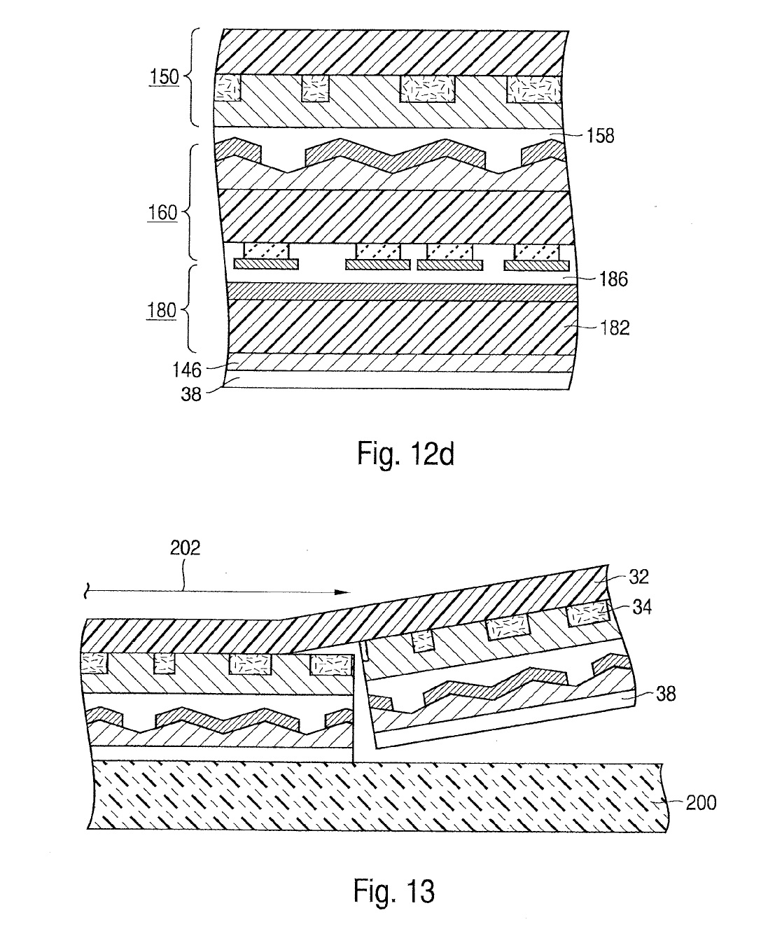

FIG. 12 the manufacture of a multilayer security element according to a further exemplary embodiment of the present invention, wherein (a), (b) and (c) show a first, second and third layered composite prior to lamination and (d) shows the finished security element,

FIG. 13 the transfer of the multilayer security element in FIG. 7 to a target substrate, and

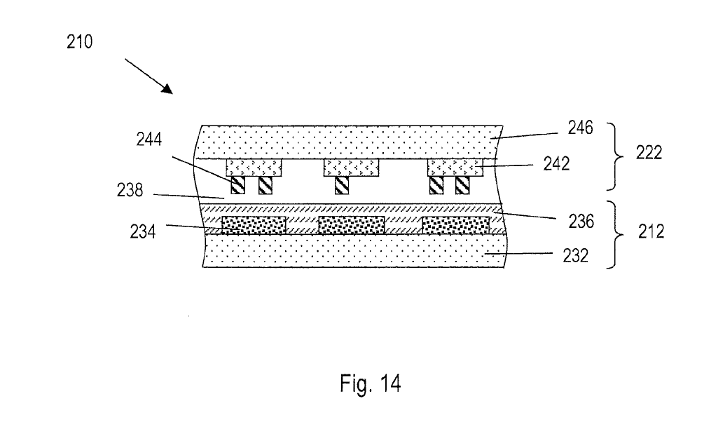

FIG. 14 a diagram of a multilayer security element according to a further exemplary embodiment of the present invention.

The invention will now be explained in greater detail using a banknote as an example. FIG. 1 shows a schematic diagram of a banknote 10 having two security elements 12 and 16, each of which is manufactured with the aid of a transfer material according to the present invention.

The first security element constitutes a security thread 12 that emerges at certain window areas 14 on the surface of the banknote 10, while it is embedded in the interior of the banknote 10 in the areas lying therebetween. The second security element is formed by a wide security strip 16 that is affixed to the banknote paper with a heat seal adhesive.

FIG. 2 shows a top view of a sub-area of the security strip 16 as it appears when viewed without auxiliary means or when viewed through a linear polarizer 20. Viewed without auxiliary means, the security strip 16 displays shiny metallic, optically variable diffraction patterns 22, such as holograms or kinegrams. Such diffraction patterns are known to the person skilled in the art and are thus not further explained in the following. Instead of the diffraction patterns 22, e.g. matte patterns or refractive patterns can also be provided.

If the security strip 16 is viewed through a linear polarizer 20, then additional structures appear, in the exemplary embodiment a honeycomb pattern 24. These patterns, which are practically imperceptible with the naked eye, can be used to check the authenticity of the banknote 10. Alternatively, the structures can also be made visible with a circular polarizer.

The structure and the manufacture of security elements according to the present invention will first be explained with reference to simpler and then increasingly more complex security element structures.

FIG. 3 shows, in cross-sectional view, an intermediate step in the manufacture of a transfer material 30 that can be used, for example, in a security thread 12 or a security strip 16 of the kind shown in FIG. 1. For this, as an effect layer, a layer 34 comprising nematic liquid crystal material is imprinted discontiguously on a transparent substrate foil 32, for example a smooth plastic foil of good surface quality. The nematic layer 34 is typically imprinted in the form of a motif comprising patterns, characters or a code, for example in the form of the honeycomb pattern shown in FIG. 2.

On the nematic layer can likewise be imprinted, discontiguously and overlapping with it at least in some areas, a further layer, not shown here, comprising liquid crystal material, e.g. comprising cholesteric liquid crystal material in the form of a motif.

To be able, in a later work step, to transfer the nematic layer 34 that is present only in some areas and, if applicable, the further layer comprising cholesteric liquid crystal material, to a target substrate, such as a security paper or a value document, on the nematic layer 34 and the substrate foil 32 is contiguously imprinted a transfer assist layer 36, e.g. a UV-crosslinkable lacquer layer, whose adhesion to the substrate foil 32 is less than to the nematic layer 34. A layer comprising cholesteric liquid crystal material or an embossing lacquer layer can also be used as the UV-crosslinkable transfer assist layer 36.

Thereafter is applied to the transfer assist layer 36 an adhesive layer 38 with which the layered composite comprising the substrate foil 32, nematic layer 34 and transfer assist layer 36 can be laminated onto a target substrate, such as a security paper, a value document or also a further thread or strip structure 35. If desired or necessary, the substrate foil 32 for the nematic layer 34 and the transfer assist layer 36 can, in a last step, be removed again by separation winding. The damageless detachability of the substrate foil 32 is ensured by the greater adhesion of the transfer assist layer 36 to the nematic layer 34.

In all embodiments, both the transfer assist layer and the adhesive layer can include machine-readable feature substances, such as magnetic, electrically conductive, phosphorescent or fluorescent substances.

Prior to the application of the adhesive layer 38, a further layer that is not shown here can be imprinted on the transfer assist layer 36. The further layer can especially be provided with gaps or in the form of patterns, characters or codes. A further, e.g. machine-readable, layer can be imprinted under this layer. Machine-readable security features can also be located in the further layer itself. The further manufacturing process then proceeds as already described in connection with FIG. 3.

In the transfer material 40 of the exemplary embodiment shown in FIG. 4, the detachability of the substrate foil 42 upon transfer is ensured by a release layer 44 that is thermally activatable under heat sealing conditions.

Since release layers normally disrupt the alignment of subsequently applied liquid crystal layers, the release-capable substrate foil 42 is provided with an alignment-promoting alignment layer 48. This can be, for example, a layer comprising a linear photopolymer, a layer having an alignment-promoting surface topography, or a layer aligned by the application of shear forces.

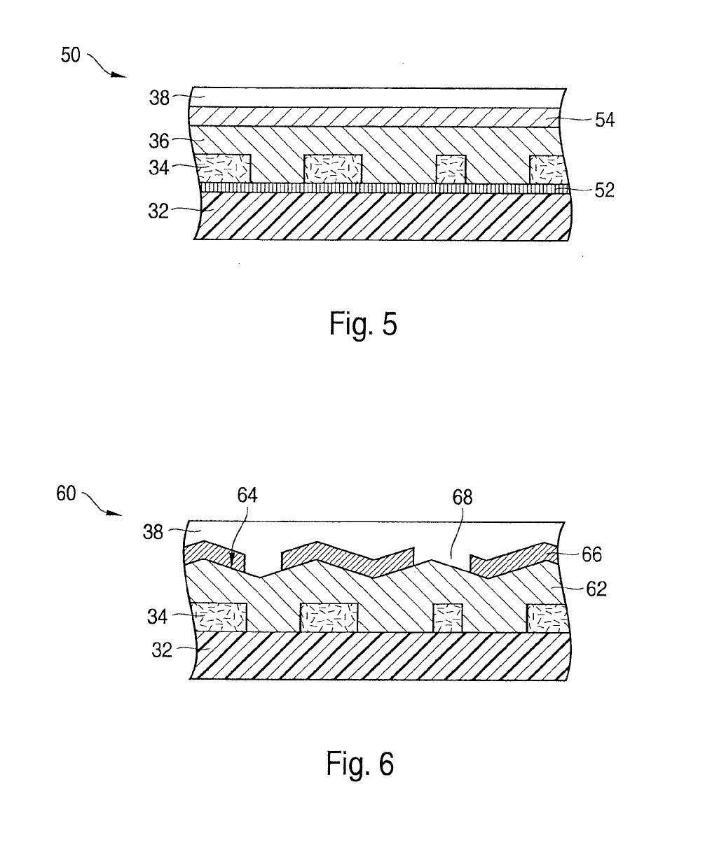

However, the use of alignment layers is not limited to transfer materials having release-capable substrate foils. FIG. 5 shows an intermediate step in the manufacture of transfer material as in FIG. 3 according to a further exemplary embodiment of the present invention. The transfer material 50 in FIG. 5 exhibits a substrate foil 32 having an alignment layer 52, for example comprising a linear photopolymer that serves to align the liquid crystals in the subsequently applied nematic, and, if applicable, cholesteric liquid crystal layers 34 and 36.

Prior to the application of the adhesive layer 38, a further layer 54 is imprinted on the transfer assist layer 36. The further layer 54 can especially be provided having gaps or in the form of patterns, characters or codes. To facilitate good perceptibility of the color and polarization effects of the liquid crystal layers, the layer 54 can be provided by an absorbent imprint or a reflective metal layer. For example, the layer can be manufactured by printing on the transfer assist layer 36 with a commercially available, especially black, printing ink. This is appropriate especially when the transfer assist layer 36 comprises cholesteric liquid crystal material. If the transfer assist layer 36 is present as a UV-crosslinkable lacquer layer, the further layer can be provided by a metal layer into which, through partial demetallization, gaps can be introduced, e.g. in the form of an inverse lettering. A further, e.g. machine-readable, layer can be imprinted under the layer 54. Further, especially machine-readable, security features can also be located in the layer 54 itself. The further manufacturing process then proceeds as already described in connection with FIG. 3.

In the transfer material having inverse lettering 60 in FIG. 6, a nematic liquid crystal layer 34 is imprinted on a substrate foil 32 that, in turn, can be provided with an alignment layer. Over the substrate foil 32 and the nematic layer 34 is contiguously imprinted a UV-curing embossing lacquer layer 62 whose adhesion to the substrate foil 32 is less than to the nematic layer 34 such that the embossing lacquer layer 62 fulfills the function of the above-described transfer assist layer when the transfer material 60 is transferred to a target substrate.

Thereafter, a desired embossing pattern 64, e.g. a diffraction pattern, is embossed in the embossing lacquer layer 62 and a reflective layer 66, especially a metal layer, applied, into which, through partial demetallization, gaps 68 are introduced, in the exemplary embodiment in the form of an inverse lettering. Alternatively, the embossing pattern 64 can also be provided with a high-index layer. Examples of high-index materials include CaS, CrO₂, ZnSi, TiO₂ and SiOₓ. Lastly, for the transfer to the target substrate, an adhesive layer 38 is applied to the layered composite.

Instead of a reflective layer 66 in the form of a metal layer or a high-index layer, the embossing pattern 64 can also be provided with a thin-film element having a color-shift effect, as is described in detail below with reference to FIG. 8.

Prior to application of the adhesive layer 38, further, especially machine-readable and/or decorative, layers can be applied to the partially demetallized embossing lacquer layer 62, especially also overlapping with the metal layer 66. For example, a commercially available printing ink can be imprinted that is then perceptible in the gaps or demetallized areas of the embossing lacquer layer when the foil material applied to a substrate is viewed. Furthermore, just like the adhesive layer 38, the printing ink can include machine-readable feature substances, such as magnetic, electrically conductive, phosphorescent or fluorescent substances.

FIG. 7 illustrates the manufacture of a multilayer security element 70 according to a further exemplary embodiment of the present invention. Here, as shown in FIG. 7(a), a first layered composite 72 is produced from a first substrate foil 32, a nematic liquid crystal layer 34 and a transfer assist layer 36 comprising cholesteric liquid crystal material, as described in connection with FIG. 3. The transfer assist layer can be formed e.g. by a UV-crosslinkable lacquer layer or a layer comprising cholesteric liquid crystal material.

In addition, as shown in FIG. 7(b), a second layered composite 74 is manufactured in that an embossing lacquer layer is imprinted on a second substrate foil 80, a desired embossing pattern, in the exemplary embodiment a diffraction pattern, is embossed in the embossing lacquer, a metal layer 84 is vapor deposited on the embossed layer 82 and, through partial demetallization of the metal layer 84, gaps 86 are produced, for example in the form of an inverse lettering.

The second layered composite 74 is laminated onto the first layered composite 72 via an adhesive layer 76 (FIG. 7(c)), as indicated by the arrow 78 linking FIGS. 7(b) and 7(a). Thereafter, the second substrate foil 80 is removed by separation winding and, for transfer, an adhesive layer 38 is applied to the layered composite produced in this way, as depicted in FIG. 7(c). Following the application of the security element 70 to the target substrate, the substrate foil 32 can also be removed such that the entire layered composite is then present without substrate foils. In this way, the features that work with polarization effects are not impaired in their effect by foils and can be viewed with high contrast.

The reduced protective function for the metallization, caused by the detachment of the second substrate foil 80, can be compensated for by protective lacquer layers. Common protective lacquer layers are optically largely isotropic and thus do not impair the perceptibility of polarizing effects.

If a layer comprising cholesteric liquid crystal material is used as the transfer assist layer 36, an additional, darkly colored layer can be applied, if applicable discontiguously, to the layered composite 74 to ensure good perceptibility of the color effect of the cholesteric liquid crystal layer. Alternatively, the embossing lacquer layer 82 can also be darkly colored.

Instead of the embossing pattern, the second layered composite can also include only a reflective layer, especially a metal layer, that is preferably integrated with large demetallization portions in a print motif. Compared with conventional designs, the transfer material according to the present invention then exhibits, with the nematic layer 34, an additional check level that can be authenticated with a polarizer.

In all designs having a reflective layer, this layer can also be substituted by a more complex reflection layer structure having particular reflection effects, such as a color-shift effect. For this, FIG. 8 shows an exemplary embodiment whose manufacture proceeds analogously to the manufacturing process described for FIG. 7.

To manufacture the multilayer security element 90 in FIG. 8, a first layered composite is produced from a first substrate foil 32, a nematic liquid crystal layer 34 and a transfer assist layer 36, e.g. a UV-crosslinkable lacquer layer, and a second layered composite from a second substrate foil to which a thin-film element 92 having a color-shift effect is applied.

In the exemplary embodiment, the thin-film element 92 exhibits a reflection layer 94, an absorber layer 98 and a dielectric spacing layer 96 disposed between the reflection layer and the absorber layer. In such thin-film elements, the color-shift effect is based on viewing-angle-dependent interference effects due to multiple reflections in the different sub-layers of the element. The absorber layer 98 and/or the dielectric spacing layer 96 can exhibit gaps in the form of patterns, characters or codes in which no color-shift effect is perceptible. The reflection layer 94, too, can exhibit gaps in the form of patterns, characters or codes that then form transparent or semi-transparent areas in the thin-film element 92.

The sequence of the layers of the thin-film element can also be reversed. Alternatively, the thin-film element can exhibit a layer sequence comprising absorber layer/dielectric layer/absorber layer or a sequence of multiple layers comprising alternating high-index and low-index dielectrics. A layer sequence comprising a reflection layer and an absorbent dielectric layer may also be used.

The second layered composite produced in this way is then laminated onto the first layered composite via an adhesive layer 76, and the second substrate foil removed by separation winding. For the transfer to the target substrate, an adhesive layer 38 is applied to the now exposed reverse of the thin-film element 92. Prior to the application of the adhesive layer 38, further machine-readable and/or decorative layers, e.g. having a magnetic ink, can be applied to the exposed reverse of the thin-film element 92. Following the transfer, the first substrate foil 32 can also be detached.

In a variation that is not shown of the exemplary embodiment in FIG. 8, a multilayer security element is produced having a liquid-crystal-based color-shift or polarization effect that, for the viewer, is perceptible from the one side of the security element, and a thin-film element having a color-shift effect that is perceptible from the second side.

The security element differs from that shown in FIG. 8 in that the transfer assist layer 36 of the first layered composite is formed from cholesteric liquid crystal material. To facilitate especially good perceptibility of the color effect of the cholesteric liquid crystal layer, the adhesive layer 76 forms, in addition, a dark, preferably black background. For this, the adhesive layer 76 can be colored or, if applicable, subsequently blackened by the action of a laser beam. The thin-film element 92 of the second layered composite exhibits a reverse sequence to the above described layer sequence, i.e. in the security element, the reflection layer is present adjoining the adhesive layer 76, and the absorber layer adjoining the adhesive layer 38.

FIG. 9 shows a transfer material 100 according to a further exemplary embodiment of the present invention, in which, as in FIG. 3, a nematic liquid crystal layer 34 and a UV-crosslinkable transfer assist layer 36, e.g. comprising cholesteric liquid crystal material, are imprinted on a smooth plastic substrate foil 32. Further, on the transfer assist layer 36 is imprinted an embossing lacquer layer, a desired embossing pattern, in the exemplary embodiment a diffraction pattern, embossed in the embossing lacquer layer, and a metal layer 104 vapor deposited on the embossed layer 102. Into the metal layer 104 are introduced, through partial demetallization, gaps 106 in the form of an inverse lettering. Instead of the metal layer 104, a transparent high-index layer that exhibits a refractive index greater than 2 can also be used. In this way, both the diffraction pattern and the liquid crystal layers 34 and 36 are contiguously perceptible on a dark background that is provided by an additional layer, for example a black imprint, or that can also be present on the target substrate.

To improve the adhesion of the embossing lacquer layer 102 to the transfer assist layer 36, the latter is advantageously previously subjected to a corona treatment or it is furnished with a suitable adhesion promoter. For the transfer to the target substrate, another adhesive layer 38 is applied to the entire layered composite. Depending on the choice of the relaying layer and the brilliance requirements, the substrate foil 32 can be removed following the application of the transfer material 100 or left on the structure.

The manufacture of a multilayer security element 110, e.g. a security thread, having a liquid-crystal-based color-shift effect, an inverse lettering and a magnetic code according to a further exemplary embodiment of the present invention will now be explained with reference to FIG. 10.

First, as shown in FIG. 10(a), a first layered composite 112 is produced from a first substrate foil 32, a nematic liquid crystal layer 34 and a transfer assist layer 36, e.g. comprising cholesteric liquid crystal material, as described for FIG. 3. A second layered composite 114 is manufactured in that a screened aluminum layer 122 having gaps in the form of an inverse lettering is applied to a second substrate foil 120, and a magnetic layer 124 is applied, in the exemplary embodiment in the form of a code, to the aluminum layer. This second layered composite 114 is depicted in FIG. 10(b). In a further embodiment not shown here, the aluminum layer 122 can also be provided as a contiguous layer having gaps, for example in the form of an inverse lettering, to which, in turn, the magnetic layer 124 is applied.

The second layered composite 114 is then laminated onto the first layered composite 112 via an adhesive layer 116 (FIG. 10(c)). Thereafter, further layers 118 that are required for the embedment of the security thread in a security paper, such as a white coating layer, can be applied to the reverse of the second substrate foil 120. Finally, for the transfer to the target substrate, an adhesive layer 38, for example a heat seal coating, is applied. The substrate foil 32 can be removed by separation winding and further layers of the thread structure, such as an adhesion promoter and a heat seal coating, can be applied to the then exposed liquid crystal layers 34 and 36.

In a variation that is not shown of the exemplary embodiment in FIG. 10, instead of the magnetic layer 124 of the second layered composite, applied in the form of a code, also a dark, especially black, layer having gaps and, in some areas, a magnetic layer, for example in the form of magnetic bits, can be used. In particular, not all black areas must at the same time also be magnetic. In this way, it is possible to optically conceal a magnetic code in the black layer.

A further variation of the exemplary embodiment in FIG. 10 that differs only in the formation of the second layered composite is depicted in FIG. 11. The second layered composite 132 of the multilayer security element 130 in FIG. 11 includes, instead of the screened aluminum layer, a contiguous, semi-transparent metal layer 136 that is applied to a substrate foil 134 and on which a magnetic layer 138 is disposed, for example in the form of a code. The further procedure in the manufacture of the security thread 130 follows the description given above in connection with FIG. 10.

FIG. 12 illustrates the manufacture of a multilayer security element 140, especially a hologram security thread having a magnetic code and nematic print according to a further exemplary embodiment of the present invention.

First, a first layered composite 150 is manufactured from a first plastic substrate foil 152, a nematic liquid crystal layer 154, a transfer assist layer 156 comprising a modified UV-curing lacquer, and a first adhesive layer 158, as shown in FIG. 12(a).

To manufacture a second layered composite 160, which is depicted in FIG. 12(b), an embossing lacquer layer is imprinted on a second plastic substrate foil 162, a desired diffraction pattern is embossed in the embossing lacquer, and on the embossed layer 164 is vapor deposited an aluminum layer 166 in which, as already described in connection with FIG. 7, gaps 168 are produced, for example in the form of an inverse lettering, through partial demetallization. A magnetic layer 170 is applied in the form of a code to the reverse, which is not coated with embossing lacquer, of the substrate foil 162. The magnetic bits of the magnetic code are then covered with a coating layer 172.

A third layered composite 180 that acts as a cover element in the finished security thread is produced by applying a contiguous metal layer 184 to a third, particularly thin plastic substrate foil 182 and providing the metal layer 184 with a further contiguous adhesive layer 186, as shown in FIG. 12(c).

Now, the first layered composite 150 with the nematic print is laminated with the aid of the adhesive layer 158 onto the top of the hologram layered composite 160 (arrow 142), and the cover layered composite 180 is laminated via the adhesive layer 186 to the magnetic-code-bearing underside of the hologram layered composite 160 (arrow 144). Further layers 146, such as a white coating layer, that are required for the embedment of the security thread in a security paper can then be applied to the reverse of the third substrate foil 182. Finally, for the transfer to the target substrate, an adhesive layer 38, for example a heat seal coating, is applied, as depicted in FIG. 12(d). The substrate foil 152 of the first layered composite 150 can then be removed by separation winding and further layers of the thread structure, such as an adhesion promoter and a heat seal coating, can be applied to the then exposed liquid crystal layers 154 and 156.

The application of the described security elements to a target substrate 200, e.g. a security paper or a plastic foil, is explained with reference to FIG. 15 by way of example based on the multilayer security element 70 in FIG. 7. For this, the security element 70 is laid with the heat seal adhesive layer 38 on the target substrate 200 and pressed on in some areas. The pressing can occur, for example, with a heated transfer stamp or a transfer roller, which are not depicted. Under pressure and heat action, the adhesive layer 38 bonds with the target substrate 200 in the desired areas 202 such that a transfer element is created, if applicable having a predetermined outline shape. The substrate foil 32 of the liquid crystal layers 34, 36 can be removed in the application process or also shortly thereafter. Prior to application of the transfer element 70 to the target substrate 200, the surface of the target substrate 200 can be specially treated. In this way, it is possible to improve especially the adhesive effect of the transfer element and the optical efficiency of the security features it provides. For example, an adhesion promoter can be applied to the surface of the target substrate 200.

The manufacture of a multilayer security element 210, e.g. of a security thread, having an inverse lettering and a concealed magnetic code according to a further exemplary embodiment of the present invention will now be explained with reference to FIG. 14.

First, a first layered composite 212 is produced from a first transparent substrate foil 232, a layer having flat metal pigments 234 that is applied, especially imprinted, in some areas, and a transfer assist layer 236, e.g. a UV-crosslinkable lacquer layer. Printing inks having such flat metal pigments yield particularly good brilliance when they are printed directly on very smooth surfaces. The transparent substrate foil should thus exhibit a good surface quality.

A second layered composite 222 is manufactured in that an aluminum layer 242 having gaps in the form of an inverse lettering is produced on a second substrate foil 246, and a magnetic layer 244 is applied, in the exemplary embodiment in the form of a code, to the aluminum layer.

The second layered composite 222 is then laminated in perfect register onto the first layered composite 212 via an adhesive layer 238. Thereafter, further layers that are not shown here and that are required for the embedment of the security thread in a security paper can be applied to the reverse of the second substrate foil 246. Finally, for the transfer to the target substrate, an adhesive layer 38, for example a heat seal coating, is applied. The substrate foil 232 can be removed by separation winding and further layers of the thread structure, such as an adhesion promoter and a heat seal coating, can be applied to the then exposed layers 234 and 236.

In such a multilayer structure, the black magnetic areas are concealed by the application of the printing ink containing highly opaque, flat metal pigments. However, if such printing inks were to be printed directly on the rough magnetic layer 244, the brilliance of the color would not be satisfactory and the visual appearance of the security element would be different on both sides.

In a further exemplary embodiment that is not depicted, the transfer material comprises an effect layer that is applied contiguously on a transparent plastic substrate foil and comprises optically variable pigments, such as interference layer pigments. Such effect layers require a very smooth background to achieve a brilliant color impression. Instead of the transparent plastic substrate foil, a lacquer layer that is applied on a transparent substrate foil and exhibits a suitable surface quality can also be used. To stabilize the effect layer upon transfer to a target substrate, if applicable, a transfer assist layer can also be applied to the effect layer.

In a variation of this exemplary embodiment, the detachability of the substrate foil from the effect layer can also be ensured by a release layer that aids the separation under the appropriate transfer conditions. The substrate foil can then e.g. additionally exhibit a release layer that is thermally activatable under heat sealing conditions, as is illustrated in the exemplary embodiment in FIG. 4, to which the effect layer is then applied.

For the transfer of the transfer material to a second layered composite, such as a further thread or strip structure, an adhesive layer is further applied to the effect layer. Alternatively, the adhesive layer can also be provided on the second layered composite. If desired or necessary, the substrate foil can, in a last step, be removed again by separation winding.

1. A method for manufacturing a multilayer security element, the security element exhibiting at least one effect layer that requires a special background, characterized by the following steps:
a) providing a first layered composite, especially a transfer material, by
providing a first plastic substrate foil that exhibits a surface that is adapted to an effect layer to be applied thereto;
applying the effect layer such that the first plastic substrate foil and the effect layer form a first layered composite;
b) providing a second layered composite that comprises a second plastic substrate foil,
c) joining the first and second layered composite such that the effect layer comes to rest on the second layered composite;
d) removing the first plastic substrate foil.

2. A method for manufacturing a first layered composite, especially a transfer material for transfer to a target substrate, having the method steps:
a) providing a plastic substrate foil that exhibits a surface that is adapted to an effect layer to be applied thereto,
b) applying an effect layer to the substrate foil,
c) contiguously applying a transfer assist layer to the effect layer and, if applicable, the substrate foil, the adhesion of the transfer assist layer to the substrate foil being less than to the effect layer, and
d) applying an adhesive layer for transferring the formed layered composite to the target substrate.

3. A method for manufacturing a first layered composite, especially a transfer material, for transfer to a target substrate, having the method steps:
a) providing a plastic substrate foil having a release layer,
b) applying an effect layer to the substrate foil,
c) contiguously applying a transfer assist layer to the effect layer and, if applicable, the substrate foil, and
d) applying an adhesive layer for transferring the formed layered composite to the target substrate.

4. The method according to claim 3, characterized in that the plastic substrate foil having a thermally activatable release layer is provided.

5. The method according to claim 3 or 4, characterized in that the release layer is provided with a surface that is adapted to the effect layer to be applied thereto.

6. The method according to at least one of claims 1 to 5, characterized in that the effect layer forms an optically effective effect layer or a reflectively acting effect layer.

7. The method according to at least one of claims 1 to 6, characterized in that a lacquer layer comprising oriented liquid crystal material or a layer having optically variable or metallic pigments is applied, preferably imprinted, as the effect layer.

8. The method according to at least one of claims 1 to 7, characterized in that the effect layer is applied to the substrate foil discontiguously.

9. The method according to at least one of claims 1 to 8, characterized in that the effect layer is formed by a first layer comprising a liquid crystal material.

10. The method according to claim 9, characterized in that at least one further liquid crystal layer is applied discontiguously between the discontiguously applied first liquid crystal layer and the transfer assist layer.

11. The method according to claim 9 or 10, characterized in that the first and/or the further liquid crystal layers are applied in the form of patterns, characters or codes.

12. The method according to at least one of claims 9 to 11, characterized in that the first liquid crystal layer and/or the further liquid crystal layers are applied, preferably imprinted, as a lacquer layer comprising nematic, cholesteric or smectic liquid crystal material.

13. The method according to claim 12, characterized in that the first liquid crystal layer and/or the further liquid crystal layers and/or the transfer assist layer are imprinted by means of intaglio printing, screen printing, flexo printing, knife coating or curtain coating.

14. The method according to at least one of claims 2 to 13, characterized in that the effect layer is applied, preferably imprinted, as a lacquer layer that includes effect pigments embedded in a binder matrix.

15. The method according to claim 14, characterized in that the transfer assist layer is applied, preferably imprinted, as a lacquer layer that includes the binder without effect pigments used for the binder matrix.

16. The method according to claim 14 or 15, characterized in that the effect layer and/or the transfer assist layer is imprinted by means of screen printing, transfer printing or pad printing.

17. The method according to at least one of claims 2 to 16, characterized in that a UV-curing lacquer layer is applied, especially imprinted, as the transfer assist layer.

18. The method according to claim 17, characterized in that the UV-curing lacquer layer includes photoinitiators.

19. The method according to at least one of claims 2 to 16, characterized in that a layer comprising cholesteric liquid crystal material is applied, especially imprinted, as the transfer assist layer.

20. The method according to at least one of claims 2 to 16, characterized in that an embossing lacquer layer that is subsequently embossed is applied, especially imprinted, as the transfer assist layer.

21. The method according to claim 20, characterized in that the embossing lacquer layer is metallized and, if applicable, demetallized in some areas.

22. The method according to at least one of claims 2 to 21, characterized in that the transfer assist layer is corona treated or furnished with an adhesion promoter.

23. The method according to at least one of claims 2 to 22, characterized in that one or more further layers are applied to, especially imprinted on, the transfer assist layer prior to the application of the adhesive layer in step d).

24. The method according to claim 23, characterized in that a further layer is imprinted on the transfer assist layer with a printing ink, preferably a magnetic ink.

25. The method according to claim 23, characterized in that a reflective layer is applied as a further layer.

26. The method according to claim 23 or 24, characterized in that, as a further layer, an embossing lacquer layer is applied, especially imprinted, that is subsequently embossed, metallized and, if applicable, demetallized in some areas.

27. The method according to at least one of claims 1 to 26, characterized in that the second layered composite is manufactured by applying an embossing lacquer layer to the second substrate foil and embossing, metallizing and, if applicable, demetallizing the embossing lacquer layer in some areas.

28. The method according to at least one of claims 1 to 26, characterized in that the second layered composite is manufactured by applying a screened metal layer, especially in the form of patterns, characters or codes, or a semi-transparent metal layer to the second substrate foil and by subsequently applying a magnetic layer to the metal layer, especially in the form of patterns, characters or codes.

29. The method according to at least one of claims 1 to 28, characterized in that the second layered composite comprises a reflective layer.

30. The method according to claim 25 or 29, characterized in that the reflective layer is formed by a metal layer.

31. The method according to claim 25 or 29, characterized in that the reflective layer is formed by a reflective thin-film element having a viewing-angle-dependent color impression.

32. The method according to claim 31, characterized in that the thin-film element is formed having a reflection layer, an absorber layer and a dielectric spacing layer disposed between the reflection layer and the absorber layer.

33. The method according to at least one of claims 1 to 28, characterized in that the second layered composite comprises an optically effective microstructure.

34. The method according to claim 32, characterized in that the optically effective microstructure is formed as a diffraction pattern, as a matte pattern, as an arrangement of microlenses or as an arrangement of micromirrors.

35. The method according to at least one of claims 1 to 34, characterized in that a smooth foil having good surface quality is provided as the substrate foil.

36. The method according to at least one of claims 1 to 35, characterized in that a foil designed for the alignment of liquid crystals is provided as the substrate foil.

37. The method according to at least one of claims 1 to 36, characterized in that a foil provided with an alignment layer for the alignment of liquid crystals is provided as the substrate foil.

38. The method according to claim 37, characterized in that a layer comprising a linear photopolymer, a layer having an alignment-promoting surface topography or a layer aligned by the application of shear forces is used as the alignment layer.

39. The method according to claim 38, characterized in that the layer having an alignment-promoting surface topography is manufactured by embossing, etching or scoring.

40. A transfer material for transfer to a target substrate, especially manufacturable according to one of claims 2 to 38, having
a security layer sequence having an effect layer and a contiguously present transfer assist layer that is disposed directly above the effect layer, and having
an adhesive layer for transferring the layer sequence to the target substrate.

41. The transfer material according to claim 40, characterized in that the effect layer is applied to the substrate foil discontiguously.

42. The transfer material according to claim 40 or 41, characterized in that the effect layer is formed by a first layer comprising a liquid crystal material.

43. The transfer material according to claim 42, characterized in that the first layer is formed from a nematic liquid crystal material.

44. The transfer material according to at least one of claims 40 to 43, characterized in that the transfer assist layer is formed from a UV-curing lacquer layer, a cholesteric liquid crystal material or by an embossing lacquer layer provided with an embossment.

45. The transfer material according to at least one of claims 40 to 44, characterized in that the effect layer and the transfer assist layer are present on a plastic substrate foil, the adhesion of the transfer assist layer to the substrate foil being less than to the effect layer.

46. The transfer material according to at least one of claims 40 to 45, characterized in that the effect layer and the transfer assist layer are present on a plastic substrate foil that exhibits a thermally activatable release layer.

47. A security element, especially a security thread, transferable security strip or patch, for securing valuable articles, manufacturable according to claim 1 or having a transfer material according to at least one of claims 2 to 46.

48. A method for manufacturing a security element, especially a security thread, a transferable security strip or a patch, in which a transfer material is manufactured according to at least one of claims 2 to 46 and is furnished with further layers for embedment in or for application to a security paper or value document.

49. The method according to claim 48, characterized in that the security element includes a carrier substrate comprising paper or plastic.
